(19) United States
(12) Patent Application Publication
(10) Pub. No.: US 2004/0221463 A1
(43) Pub. Date: Nov. 11, 2004

(54) Flexible level

(76) Inventor: Vearl Patrick Hexamer JR., Anderson, IN (US)

Correspondence Address: John D. Ritchison, RITCHISON LAW OFFICES, PC, Suite A, 115 East Ninth Street, Anderson, IN, 46016-1509, US

(21) Appl. No.: 10/839,453

(22) Filed: May 5, 2004

Related U.S. Application Data
(60) Provisional application No. 60/468,597, filed on May 7, 2003.

(51) Int. Cl. G01C 9/10

(52) U.S. Cl. 33/365

(57) ABSTRACT

A flexible level is provided that includes a main body comprised of flexible material with bubble devices built in that can be used with the tool in a horizontal (level) or vertical (plumb) positions. The material, when embodied in the configuration of the level, provides 360 degree flexibility in the longitudinal direction, yet rigidity in the other directions. This device has measurement and other features to enhance its use. The full configuration of the device permits one to level and measure around contours of various shaped objects, at interior or exterior corners of structures, and around other various items and places which heretofore required either two people or more complicated devices or tools.

### CROSS-REFERENCE TO RELATED APPLICATIONS

This application claims the benefit of Provisional Patent Application Ser. No. 60/468,597 filed May 7, 2003 by Vearl Patrick Hexamer, Jr. and titled “FLEXIBLE LEVEL”.

### FIELD OF INVENTION

The present device relates to the field of tools that indicate the level condition of things. The level is made of flexible materials and has features to indicate measurements and to enable easy use by one person. These features permit one to level and measure around various shaped objects, at interior or exterior corners of structures, and around other various items and places which heretofore required either two people or more complicated devices or tools.

### FEDERALLY SPONSORED RESEARCH

Not Applicable.

### SEQUENCE LISTING OR PROGRAM

Not Applicable

### BACKGROUND-FIELD OF INVENTION

The new flexible level described in this specification is a tool that is designed to assist skilled and non-skilled craftsmen in attaining an indication of a level condition of various points around the exterior of regular and irregular shaped objects or interior and exterior of corners of structures. The level measuring device can help a person to determine that two or more points in different intersecting planes are at the same height. The present device may be utilized to indicate and/or mark horizontal and/or vertical positions on curved surfaces.

A. Introduction of the Problems Addressed

Historically, it has been difficult to accurately, economically, and simply measure regular and irregular shaped objects and corners for a condition of levelness around their exterior or interior surfaces. For levels that are accurate, the set-up and preparation for use has been complex and time consuming. Equally burdensome is the high cost of such a device in comparison to a standard carpenter's level. For a cost effective method that approaches or is less than a standard carpenter's level, the accurateness has traditionally been compromised by using ineffective structural designs or materials that have less stiffness to bending. What is needed is a cost-effective level that can be easily used and that can provide a repeatable and accurate indication of levelness.

B. Prior Art

Several different devices have attempted to address the problem as stated. In use, the prior art device is placed on or against a surface to indicate whether the surface is substantially horizontal or vertical. However, the devices have not solved the needs of ease of use, accurateness, and relatively inexpensive compared to a carpenter's level like the flexible level presented here.

Examples of prior level innovations begin with U.S. Pat. No. 2,559,961 issued to Howell (1951). This teaches a multiple jointed, articulated level device. Each section is linked by pins that permit significant sag or cumulative droop that degrades the accurateness of the device. A flexible level device for sports enthusiasts was issued to Morrison as a U.S. Pat. No. 3,269,729 (1966). It teaches a small watch-like strap with a bubble mechanism. The device is worn on a wrist and indicates level condition to the arm versus the surrounding terrain. This shows a flexible leather or material strap. It does not provide sufficient length or stiffness for accuracy as described as problematic, above.

Other examples include a U.S. Pat. No. 4,070,764 issued to Rohlinger (1978) which teaches a collapsible ruler and level on a spring-like strap. The tension on the metal strap makes the device difficult to maneuver and the offset bubble degrades the accuracy of the level indication. A U.S. Pat. No. 4,100,681 issued to Hollander (1978) teaches a picture frame leveling device. This is another sectioned device with cumulative degradation in tolerances between sections which degrades the accuracy of the device. It also teaches a bubble device on each section which significantly increases the cost of the device.

A flexible tube level U.S. Pat. No. 4,759,134 was issued to Chrisley (1988) that teaches a long, complicated method to measure the levelness of an object. The device provides some improvement to the classic, clear hose level used by contractors for generations, but the use is more cumbersome and difficult than the new flexible level described herein. Another picture frame level device is taught in U.S. Pat. No. 5,463,817 issued to Leeds (1995). This tool shows a continuous, fluid filled device that compacts into a rolled, thick tape-like configuration. It also teaches a sectioned alternative embodiment. The continuous fluid filled device increases the cost while the sectioned devices increase the cost and detract from the accuracy.

A flexible leveling device is taught in U.S. Pat. No. 5,560,116 issued to Tobia (1996). This tool shows a multi-part, adjustable strap as one embodiment and describes a rubber, leather or stainless material for the body of the level. It also shows multiple sectioned device as another embodiment. It describes a complex method of operation and several expensive manners to attach the bubble devices.

A recent device and diagnostic tool is taught in U.S. Pat. No. 6,349,478 B1 issued to Ramsey, Jr. (2002). This tool focused on widow and windshield measurement. It is a flexible device particular to use in the original equipment manufacturing and the repair industry for motor vehicles. The teaching does not address the scope of the present problem as stated. None of the prior art teaches all the features and capabilities of the Flexible Level.

### SUMMARY OF THE INVENTION

This device is a flexible level with measurement and other features to enhance its use. These features are built-in and include level indicating bubble devices that can be used with the tool in a horizontal (level) or vertical (plumb) positions. The material comprising the main body of the device is flexible. This material, when embodied in the configuration of the level, provides 360 degree flexibility in the longitudinal direction, yet rigidity in the other directions. The flexibility provides the level with a capability to follow the contours of various odd shaped objects as well as the interior and exterior corners of structures. Other features include indicators along the body of the tool in both the English and Metric linear measurement systems. Finally, there are additional features to enable a person to use the device by oneself without additional help.

### OBJECTS AND ADVANTAGES

Accordingly, there are several objects and advantages of the FLEXIBLE LEVEL. One advantage of this device over others in the field is the simplicity of use. Unlike more complex devices, this flexible level can be operated easily by one person to verify or establish the level points of contours on various odd shaped objects as well as the interior and exterior corners of structures.

Another advantage is the multiple measurement indicators along the body of the flexible level. It has the ability to show both English and Metric linear measurement and therefore can be used throughout a global environment.

A further advantage is the inexpensive design. The use of the same type of level “bubble devices” for both the horizontal and vertical indicators permit the manufacturing process to have the advantage and economy of scale for the purchased components.

Another design feature is the durable, yet flexible material used for the main body of the level. The materials selected afford a long, useful life of the product without undue cost to have the proper material to enable the flexibility in only the longitudinal direction of the level.

Finally, other advantages and additional features of the present level will be more apparent from the accompanying drawings and from the full description of the instant device. For one skilled in the art of level measuring tools and level devices it is readily understood that the features shown in the examples with this instant device are readily adapted to other types of level indicating tools and devices.

### DESCRIPTION OF THE DRAWINGS—FIGURES

The accompanying drawings, which are incorporated in and constitute a part of this specification, illustrate an embodiment of the present level that is preferred. The drawings together with the summary description given above and a detailed description given below serve to explain the principles of the flexible level. It is understood, however, that the level is not limited to only the precise arrangements and instrumentalities shown.

FIG. 1 is a Top or Plan View of the device—a flexible level.

FIG. 2 is an Isometric View of the level depicting its ability to bend and flex in the longitudinal direction.

FIG. 3 is the End View of the flexible level to depict the relationship of the width and thickness of the device.

FIG. 4 is a series of diagrams to enable a discussion of the bending of the device. Specifically:

FIG. 4A is the End View of the flexible level with the bending axis shown for that view.

FIG. 4B is the Plan View of the flexible level with the bending axis shown for that view.

FIG. 4C is the Top View of the flexible level with the bending axis shown for that view.

FIG. 5 is an Isometric View of the flexible level coiled into a spiral for storage or packaging.

FIG. 6 is a Top View of the flexible level coiled into a spiral for storage or packaging.

FIG. 7 is an enlarged Section of the Plan View of the flexible level at an area where a “bubble device” is located.

FIG. 8 is various Cross Sections of possible “bubble device” mountings:

A-A is a mounting attached in a partial recess of the flexible level.

B-B is a mounting in a partial recess of the flexible level with a face plate.

C-C is a mounting in a complete recess or aperture through the main body of the flexible level.

D-D is a surface mounting on the flexible level with a securing device.

E-E is a surface mounting on the flexible level with an adhesive material securing the device to the level surface

FIG. 9 is the Plan View showing the measuring demarcations.

FIG. 10 is an enlarged Section of the Plan View at one end of the flexible level that shows various types of apertures that may assist in the one person use of the flexible level.

### DESCRIPTION OF THE DRAWINGS—REFERENCE NUMERALS

The following list refers to the drawings:

20 flexible level

21 body of the level

22 holding aperture

23 vertical bubble device

24 English measurement indicators

25 horizontal bubble device

26 thickness of level

27 width of flexible level

28 three dimensional center point of flexible level

29 vertical axis of level

30 bending axis

31 second bending axis

32 partial recess

33 adhesive material

34 face plate device

35 full recess

36 surface mount device

37 metric measuring demarcations

38 a square holding aperture

39 an ellipse aperture

40 a triangle holding aperture

### DETAILED DESCRIPTION OF PREFERRED EMBODIMENT

The present flexible level has various features to enhance its use. These features are built-in to the main body of the device. The material comprising the main body of the device is flexible. This flexibility in the designed configuration provides the level a capability to follow the contours of various odd shaped objects as well as the interior and exterior corners of structures. Other features include indicators in both the English and Metric linear measurement systems. Finally, there are features to enable a person to use the device by oneself without additional help. A person having ordinary skill in the field of this type of level device appreciates the various materials and component parts that may be used to physically permit this flexible level to be produced and utilized.

The improvements over the existing art are providing a device that:

is simple and inexpensive to manufacture;

has fewer and more simply designed parts when compared to complex levels; and, is superior to other levels in its price range in its design for repeatable and accurate indication of the level points for various odd shapes and contours.

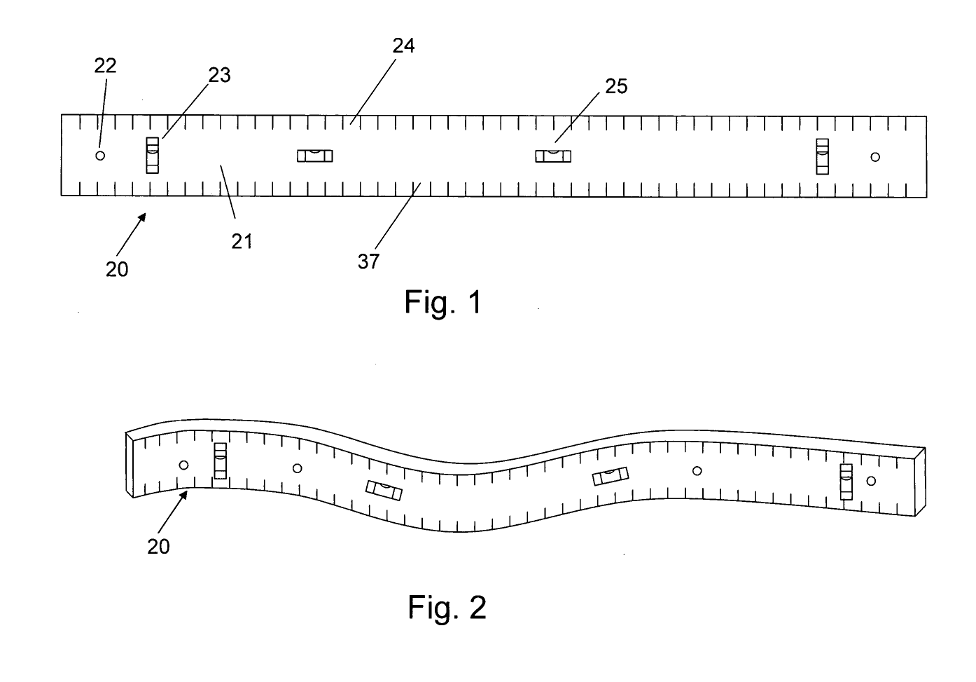

There is shown in FIGS. 1-10 a complete operative embodiment of the level. The embodiment generally relates a flexible device or tool to indicate the level condition of various odd shapes and contours. While the present embodiment shows a level that is approximately thirty-six to forty eight inches in length as a flexible level, this showing is not meant to limit the intention of the instant device. The same concept applies to other levels of varying lengths and cross sections.

In the drawings and illustrations, note well that the FIGS. 1-10 demonstrate the general condition of a level having two sets of functional parts for each direction (e.g. two vertical and two horizontal bubble indicators). This is done for simplicity and it is understood that many times in the descriptions, below, only one set will be referenced. The use of one, two or a plurality of the bubble devices is possible. For simplicity in illustrating the level, please note that the manner of attaching any of the bubble components to the body of the level is not repeated for more than one bubble device. The manner of attachment is functionally understood by those skilled in the art to be appropriate to attach all the devices.

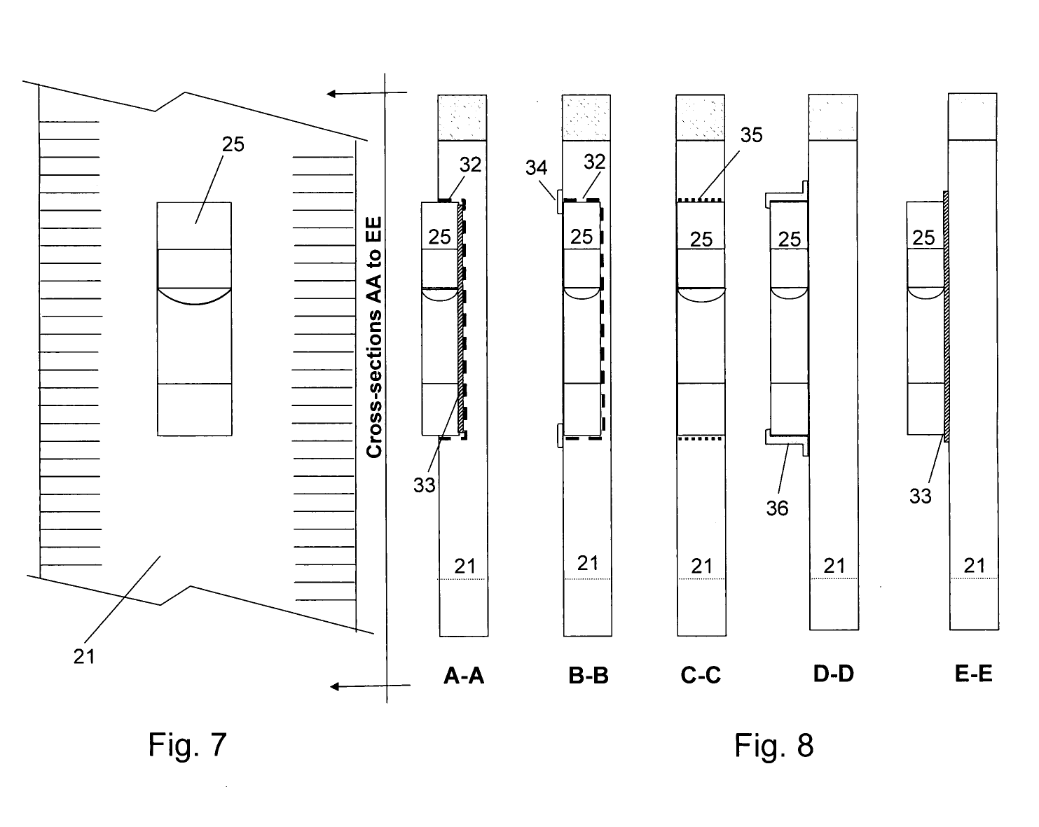

The preferred embodiment of the flexible level 20 is comprised of a few parts as shown in FIGS. 1-10 of the drawings. These parts include, but are not limited to, the main body 21 of the flexible level 20; vertical 23 and horizontal 25 bubble devices; a holding aperture 22; and various ways to mount or attach the bubble devices 23 and 25 to the main body 21. Note these parts are shown in the cut away views and illustrations in FIGS. 7 and 8.

FIG. 1 is a Top or Plan View of the device—a flexible level. This view delineates the main level body 21 and the multiple holding apertures 22 to help use the flexible level by one person. The person may attach or hang one end of the device on the odd-shaped contour or corner structures. The various bubble devices 23 and 25 are shown attached to the main body 21 of the level to permit easy reading of the level condition. Finally this FIG. 1 demonstrates that the main body 21 may have measurement indicators 24 and 37 along the edges of the main body 21 to enable a person to mark linear measurements with the level.

FIG. 2 is an Isometric View of the level depicting its ability for the flexible level 20 to bend and flex in the longitudinal direction.

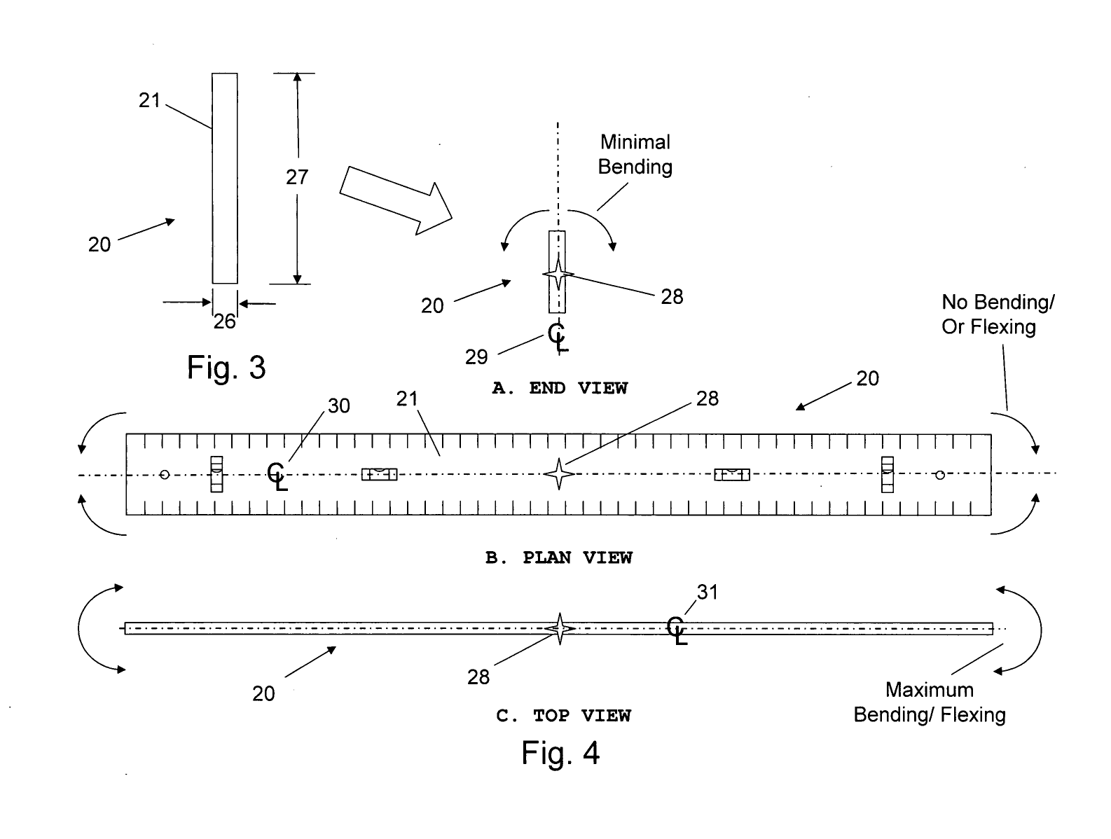

FIG. 3 is the End View of the flexible level 20 to depict the relationship of the width 27 and thickness 26 of the device. The main body 21 consists of a resilient and durable material such as various metals, plastics, composite materials, relatively high durometer rubbers and other flexible materials. There is an importance in having the thickness 26 as a small dimension compared to the width 27. The ratio may vary with different materials, but the ratio can be empirically confirmed by simple tests in a laboratory setting. The importance of the empirically determined ratios is shown in FIG. 4

FIG. 4 shows diagrams to enable this discussion regarding the bending of the flexible level 20. Specifically FIG. 4A is the END VIEW of the flexible level body 20 with the bending axis shown for that view. The proper relationship of the thickness 26 and width 27 for a given material should result in MINIMAL BENDING along the vertical axis 29 splitting the thickness 26 at the center point 28 of the main body of the level

Further diagrams of the relationships are shown in FIG. 4B, the Plan View of the flexible level 20. Here, the bending axis 30 is along the length of the main body 21. NO BENDING or FLEXING should occur along that axis 30 shown in this view. Again, the relationship of the thickness 26 and width 27 for a given material should establish this condition for the specific material chosen.

Finally, in FIG. 4C is the Top View of the flexible level with the second bending axis 31 shown for that view. Here the relationship of the thickness 26 and width 27 should provide MAXIMUM BENDING and FLEXING for the device. This is a KEY to the usefulness of the level.

As mentioned above, the relationship of the thickness and width will vary by the selected material. This relationship is appreciated by one skilled in the art of materials and skilled in the design of flexible cross sections. For example, if one were to select a flexible plastic like a common sheet of building material known as PLAS-TER WATERPROOF BRIGHT WHITE (Parkland Plastics Inc.) and one were to determine empirically a ratio, the study would show that the determined ratio [of the thickness 26 of sixty thousandths of an inch (0.060″) to the width 27 of two inches (2″)] provides a very suitable flexible level main body 21. The condition established by this material and ratio will minimize or eliminate bending in two axes 29 and 30 while providing a high degree of flexibility and bending along axis 31 of the flexible level 20. One skilled in the art appreciates that this is only one example and is not intended to limit the plethora of materials and associated ratios of dimensions that could be empirically established for this device.

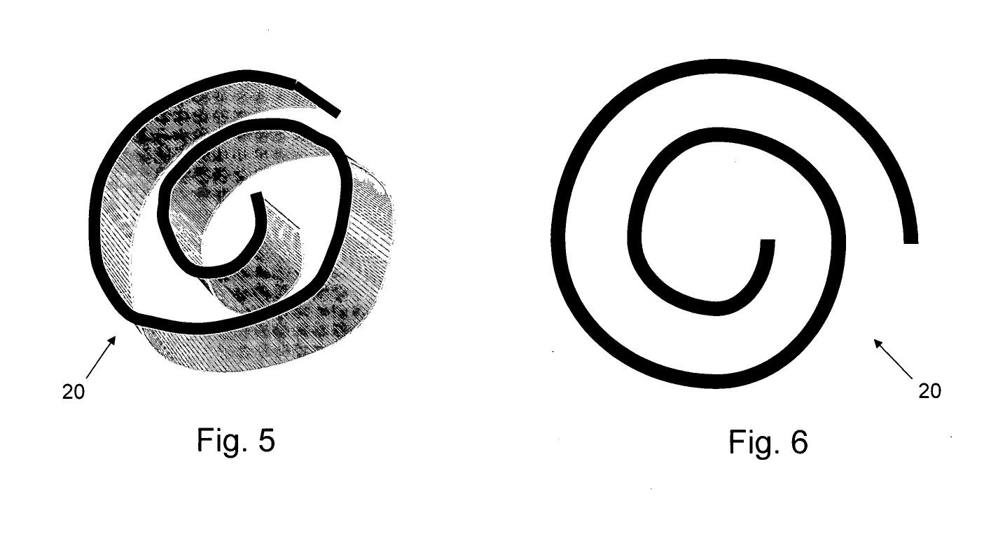

FIG. 5 is an Isometric View of the flexible level 20 coiled into a spiral for storage or packaging. The flexibility that is useful as a measuring tool can provide a compact and less expensive way to package and ship the device as well as a smaller package for in store presentation and marketing of the tool.

FIG. 6 is a Top View of the flexible level 20 coiled into a spiral. It is a one-dimensional demonstration of the same features just described in FIG. 5 for storage or packaging.

FIG. 7 is an enlarged Section of the Plan View of the flexible level main body 21 at an area where a “bubble device” 25 is located. The section view pertains to all devices whether mounted in the horizontal or vertical configuration.

FIG. 8 shows cross-sections of the “bubble device” 25 for various mountings to the main body 21.

In A-A a bubble device 25 is mounted or attached in a partial recess 32 of the flexible level main body 21. The bubble device 25 may be secured by a press fit into the main body 21; by an adhesive material 33 in the recessed cavity 32; or by another manner to securely attach the bubble device to the main body 21.

In B-B a different mounting is demonstrated in a partially recessed cavity 32 of the flexible level 21. In this view, the bubble device 25 is secured to the main body 21 by a face plate device 34.

In C-C the bubble device 25 is secured to the main body 21 in a full recess or aperture 35. The bubble device 25 could be press fit or secured by similar ways shown in Sections A-A or B-B.

In D-D the bubble device 25 is rigidly secured to the main body 21 by way of a surface mounting device 36.

In E-E the bubble device 25 is secured to the main body 21 by an adhesive 33.

All the section views delineated above are provided as examples and not limitations for the concept of attaching the bubble devices 25 to the main body 21 of the flexible level 20.

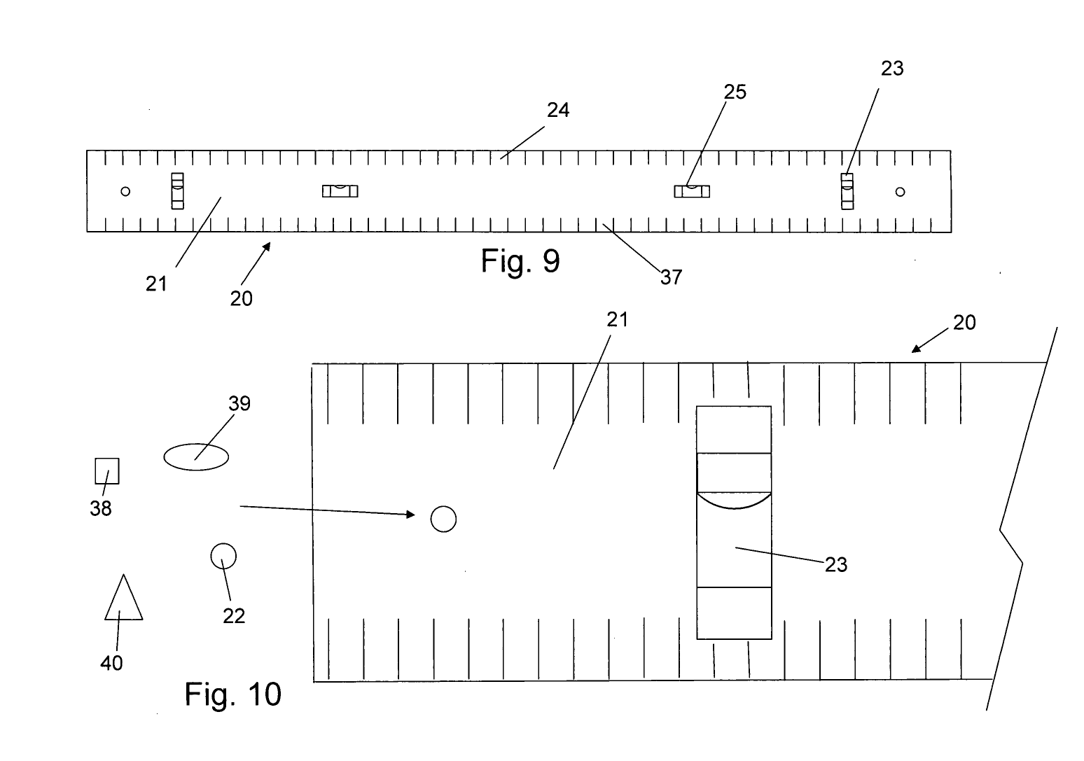

FIG. 9 is the Plan View showing the various measurement demarcations. As aforementioned, both English 24 and Metric 37 measuring demarcations could be utilized to afford use throughout a global environment.

FIG. 10 is an enlarged Section of the Plan View at one end of the flexible level. This view shows various types of apertures that assist in the one person use of the flexible level. The apertures can be of various shapes such as a circle 22; a square 38; an ellipse 39 or a triangle 40. These are exemplary and not limiting shapes for the apertures.

In total, all the points and details mentioned here throughout this detailed description of the drawings are exemplary and not limiting. Other components specific to describing a flexible level may be added. A person having ordinary skill in the field of these types of devices well appreciates this possibility of additions. The drawings and components have been focused on the parts shown in respect to the instant level device.

### OPERATION OF THE PREFERRED EMBODIMENT

The new flexible level has been described in the above embodiment. The manner of how the level operates is described below. Note well that the description above and the operation described here must be taken together to fully illustrate the concept of the present level.

The embodiment described above is a flexible level 20 comprised of a main body 21 with one or more bubble devices 23 and 25, holding apertures 22 and measuring demarcations 24 and 37. The bubble devices 23 and 25 may be mounted to the main body 21 of the level by various mountings as shown in FIGS. 7 and 8. These components and material are configured to provide the whole known as the flexible level.

The embodiment of the level may be used by a person in several manners to determine level points around odd-shaped objects or at interior or exterior corner structures. The basic principles of using a level are similar to other levels in this field. A first point is determined that one desires to be the reference point. The flexible level 20 is then held by hand or attached in respect to the reference point by hanging the level from one of the holding apertures 22. The other end of the flexible level is then adjusted up and down (for a horizontal “level” use) or back and forth (for a vertical “plumb” use) until the bubble device 23 or 25 aligns itself in the glass of the device and indicates level or plumb condition, respectively. When this condition of level or plumb is achieved, the person can then demark or indicate a second point or line at the edge of the flexible level that is, in fact, in a level (or plumb) condition with respect to the first reference point.

The advantage of having the body of the level to be flexible is readily understood by one skilled in the art. The ability to mark odd-shaped object or non linear objects such as pieces of sculpture, art work and large building columns are but a few examples. Further examples of uses for the flexible level are in marking interior or exterior corner structures to enable a person to efficiently determine a level condition. This condition is helpful for example to hang pictures; to properly place moldings such as chair rails; or to permit one to maintain a level line for a painting or a wall papering design scheme. These uses for indicating a level condition on odd shaped objects and corner structures are merely exemplary and not limiting to the myriad of uses for a tool that is flexible such as the present device.

The flexible level has been described above in connection with what is presently considered to be the most practical and preferred embodiment. With this description it is to be understood that the level is not to be limited to the disclosed embodiment. On the contrary, the flexible level is intended to cover various modifications and equivalent arrangements included within the spirit and scope of the description.

What is claimed as new and desired to be protected by Letters Patent is:

1. A flexible leveling device for use by one person on a curved surface, the flexible leveling device comprising:
(a) an elongated main body of flexible material having a longitudinal axis that is capable of a 360 degree flexion about the longitudinal axis;
(b) one or more bubble level indicating devices;
(c) a means to attach said bubble device to said main body whereby the flexible level device permits the bubble device to indicate whether the longitudinal axis is substantially horizontal.

2. The level device according to claim 1 wherein the cross section of the main body is substantially rectangular.

3. The level device according to claim 1 wherein the cross section of the main body is substantially ovular.

4. The level device according to claim 1 wherein the flexible material is metal.

5. The level device according to claim 1 wherein the flexible material is a composite material.

6. The level device according to claim 1 wherein the flexible material is substantially a high durometer rubber.

7. The bubble level device according to claim 1 wherein there are two or more bubble devices in which at least two are juxtaposed perpendicular to each other whereby one indicated a relative position to horizontal and the other a relative position to vertical.

8. The level device according to claim 1 wherein the bubble level device is a spirit level.

9. The level device according to claim 1 wherein the means for attachment is an adhesive juxtaposed between the main body and each bubble device.

10. The level device according to claim 9 wherein the main body has a partial recess for the bubble device.

11. The level device according to claim 1 wherein the means for attachment is a face plate attached to the main body.

12 The level device according to claim 11 wherein the main body has a partial recess for the bubble device.

13. The level device according to claim 1 wherein the main body has a means for indicating linear measurement demarked on a face and edge of the main body.

14. The level device according to claim 13 wherein the linear measurement indicator is in English.

15. The level device according to claim 13 wherein the linear measurement indicator is in Metric.

16. The level device according to claim 13 wherein there is two linear measurement indicators, one indicator is in English and one indicator is in Metric.

17. The level device according to claim 1 wherein the main body has an aperture at either end whereby said aperture permits the person using the device to attach the flexible level to the surface that the user is measuring for levelness.

18. A flexible leveling device for use by one person on a curved surface, the flexible leveling device comprising:
(a) an elongated main body of flexible material having a longitudinal axis that is capable of a 360 degree flexion about the longitudinal axis;
(b) a bubble level devices for indicating relativity to horizontal and a second bubble device juxtaposed 90 degrees from the first for indicating relativity to vertical;
(c) a means to attach said bubble device to said main body whereby the device permits the bubble devices to indicate whether the longitudinal axis is substantially horizontal and/or vertical.

19. The level device according to claim 18 wherein the material of the main body is made of a material substantially the same composition as PLAS-TER WATERPROOF BRIGHT WHITE, said material which is manufactured by Parkland Plastics, Inc.
